(19) United States
(12) Patent Application Publication
(10) Pub. No.: US 2013/0346424 A1
(43) Pub. Date: Dec. 26, 2013

(54) COMPUTING TF-IDF VALUES FOR TERMS IN DOCUMENTS IN A LARGE DOCUMENT CORPUS

(71) Applicants: Xiong Zhang, Shanghai (CN); Hung-chih Yang, Bellevue, WA (US); Danny Lange, Sammamish, WA (US)

(72) Inventors: Xiong Zhang, Shanghai (CN); Hung-chih Yang, Bellevue, WA (US); Danny Lange, Sammamish, WA (US)

(73) Assignee: MICROSOFT CORPORATION, Redmond, WA (US)

(21) Appl. No.: 13/528,874

(22) Filed: Jun. 21, 2012

(51) Int. Cl. G06F 17/30

(52) U.S. Cl. 707/750; 707/E17.032; 707/E17.008

(57) ABSTRACT

Technologies pertaining to computing a respective TF-IDF value for each term in each document of a relative large document corpus are described herein. TF-IDF values are computed with respect to terms in documents of a large document corpus by in a single pass over the document corpus. Secondary sorting functionality of a distributed computing framework is exploited to compute TF-IDF values efficiently.

### BACKGROUND

There are currently an incredibly large number of documents available on the World Wide Web. Furthermore, web-based applications allow users to easily generate content and publish such content to the World Wide Web. Exemplary web-based applications include social networking applications that are employed by users to post status messages, commentary, or the like, micro-blogging applications, wherein a user can generate and publish relatively short messages (up to 140 characters in length), web log(blog) applications that facilitate user creation of online accessible journals, amongst other web-based applications. Additionally, as the public is becoming increasingly proficient with computing technologies, more and more people are creating web pages that are accessible on the World Wide Web by way of a web browser.

As the number of web-accessible documents has increased, it has become increasingly challenging to identify keywords that are descriptive of content of such documents (for each document). For example, identifying descriptive keywords of a web-based document can facilitate classifying web-based documents in accordance with certain topics, identifying subject matter trends which can be employed in connection with selecting advertisements to present to users, for utilization in information retrieval, such that when a user issues a query that includes one or more of the keywords that are known to be relevant to content of a web-based document, the web-based document that includes the keyword will be positioned relatively prominently in a search results list.

An exemplary approach for identifying keywords that are descriptive of content of documents is computing term frequency-inverse document frequency (TF-IDF). This metric, described generally, combines two different metrics (a first metric and a second metric) to ascertain a score for a keyword in a document. The first metric is the frequency of the keyword in the document being analyzed. For example, if the keyword occurs multiple times in the document, then such keyword may be highly descriptive of the content (the topic) of the document. The second metric is the inverse document frequency, which indicates, for a corpus of documents that includes the document, a number of documents that include the keyword. For example, if every document in the document corpus includes the keyword, then such keyword is likely not descriptive of content of any of the documents (such keyword occurs in most documents, and therefore is not descriptive of content of any of the documents).

Computing TF-IDF for each term in each document of a relatively large corpus of documents is too large a task to be undertaken on a single computing device. Accordingly, algorithms have been developed that leverage parallel processing capabilities of distributed computing environments. Thus, the task of computing TF-IDF, for each keyword/document combination in a relatively large corpus of documents, is distributed across several computing nodes, wherein the several computing nodes perform certain operations in parallel. Conventional algorithms for execution in the distributed computing environments, however, require multiple map-reduce operations (e.g., four map reduce operations). As a result, the input/output overhead of computing nodes in the distributed computing environment is relatively high.

### SUMMARY

The following is a brief summary of subject matter that is described in greater detail herein. This summary is not intended to be limiting as to the scope of the claims.

Described herein are various technologies pertaining to computing a respective metric for each term in each document in a relatively large document corpus, wherein the respective metric is indicative of the descriptiveness of a respective term with respect to content of the document that include the respective term. Pursuant to an example, the metric can be term frequency-inverse document frequency (TF-IDF). Moreover, the metric can be computed for each term that occurs in each document of the document corpus through employment of a distributed computing programming framework that is employed in a distributed computing environment, wherein the metric is computed for each term in each document in the document corpus in which a respective term occurs utilizing a single input pass over the document corpus.

A document corpus includes a plurality of documents, wherein each document in the plurality of documents comprises a plurality of terms. A first subset of computing nodes receives the plurality of documents and executes the following acts over the plurality of documents substantially in parallel. First, a document is received at a first computing node in the first subset of computing nodes, and the first computing node generates a list of terms that are included in the document and stores such list of terms in a memory buffer of the first computing node. The first computing node generates a hash table, wherein the hash table is organized such that keys of the hash table are respective terms in the document and values corresponding to such keys are respective numbers of occurrences of the terms. Accordingly, the first computing node can sequentially analyze terms in the list of terms, and if a term is not already included in the hash table, can update the hash table to include the term and update a value of the hash table to indicate that the term has occurred once in the document. Moreover, when updating the hash table to include the term, the first computing node can output a data packet that indicates that the document includes the term.

If the term is already existent as a key in the hash table, then the first computing node can update a value corresponding to such term in the hash table by incrementing such value by one. Subsequent to generating the hash table, the first computing node can determine a number of terms in the document by summing values in the hash table (or counting terms in the list of terms). Based upon the number of terms in the document and the values in the hash table for corresponding terms, the first computing node can compute, for each term in the document, a respective term frequency. The term frequency is indicative of a number of occurrences of a respective term relative to the number of terms in the document. The first computing node can then output data packets that are indicative of term respective term frequencies for each term in the document. Other computing nodes in the first subset of computing nodes can perform similar operations with respect to other documents in the document corpus in parallel.

A second subset of computing nodes in the distributed computing environment can receive term frequencies for respective terms in respective documents of the document corpus. Additionally, a computing node in the second subset of computing nodes can receive, for each unique term, a respective value that is indicative of a number of documents in the document corpus that include a respective term. In other words, based upon data packets received from the computing nodes in the first subset of computing nodes (output when forming hash tables), computing nodes in the second subset of computing nodes can compute a respective inverse document frequency value for each unique term in documents in the document corpus. Again, the inverse document frequency is a value that is indicative of a number of documents in the document corpus that comprise the respective term.

Thereafter, utilizing respective term frequency values for terms in documents received from computing nodes in the first subset of computing nodes, computing nodes in the second subset of computing nodes can compute the metric that is indicative of descriptiveness of a respective term with respect to content of a document that includes the term (e.g., TF-IDF). In an exemplary embodiment, this metric can be employed in connection with information retrieval, such that when a query that includes a term is received, documents in the plurality of documents are respectively ranked based at least in part upon metrics for the term with respect to the documents. In another exemplary embodiment, the metric can be employed to automatically classify documents to surface terms that are descriptive of a topic of a document, to identify stop words in a document, or the like.

Other aspects will be appreciated upon reading and understanding the attached figures and description.

### BRIEF DESCRIPTION OF THE DRAWINGS

FIG. 1 is a functional block diagram of an exemplary system that facilitates computing, for each term in each document in a document corpus, a metric that is indicative of descriptiveness of a respective term with respect to a document that includes such term.

FIG. 2 is a functional block diagram of an exemplary system that facilitates computing a respective term frequency for each term in each document of a document corpus in a single pass over the document corpus.

FIG. 3 illustrates an exemplary component that sorts data packets output by a plurality of computing nodes in a distributed computing environment.

FIG. 4 is a functional block diagram of an exemplary component that facilitates computing a metric that is indicative of descriptiveness of a term relative to content of a document that includes the term.

FIG. 5 is a flow diagram that illustrates an exemplary methodology for computing, for each term in each document of a document corpus, a respective term frequency-inverse document frequency (TF-IDF) value.

FIG. 6 is a flow diagram that illustrates an exemplary methodology for computing, for each term in each document of a document corpus, a respective TF-IDF value.

FIG. 7 illustrates an exemplary computing device

### DETAILED DESCRIPTION

Various technologies pertaining to computing, for each term in each document of a document corpus, a respective metric that is indicative of descriptiveness of a respective term with respect to content of a document that includes the term will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

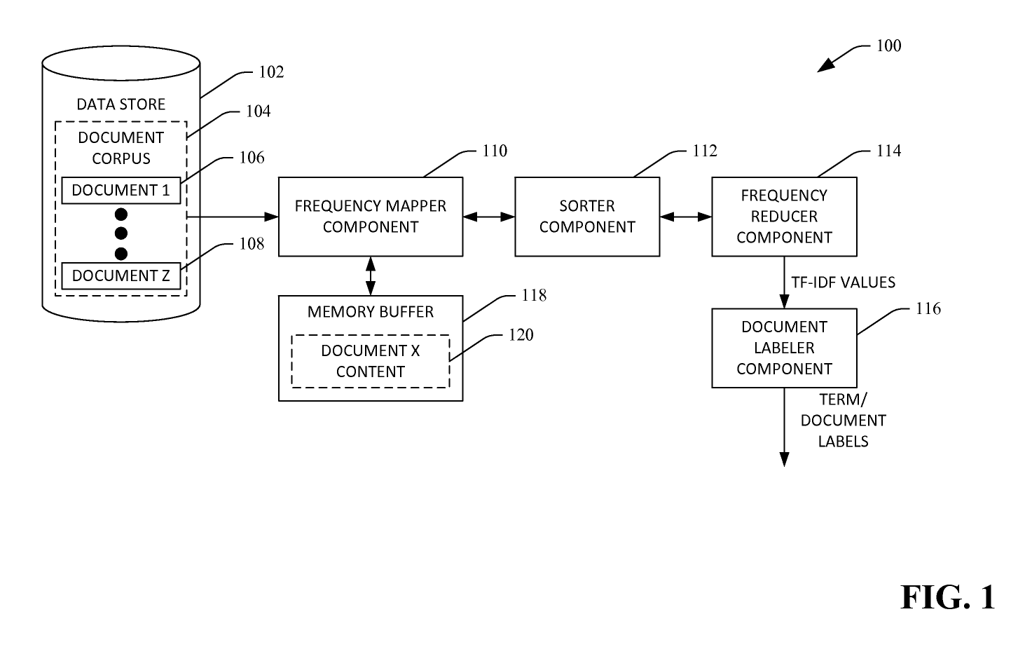

With reference now to FIG. 1, an exemplary system 100 that facilitates computing, for each term in each document of a document corpus, a respective value that is indicative of descriptiveness of a respective term with respect to content of a document that include such term. Pursuant to an example, such value can be a term frequency-inverse document frequency (TF-IDF) value. The system 100 is particularly well-suited for execution in a distributed computing environment that comprises a plurality of computing nodes that are in communication with one another, directly or indirectly, and are executing in parallel to perform a computing task. A computing node, as the term is used herein, can refer to a standalone computing device, such as, a server, a personal computer, a laptop computer, or other suitable computing device that comprises a processor that executes instructions retained in a memory. A computing node may also refer to a processor core in a multi-core processor and memory associated therewith. Still further, a computing node can refer to hardware that is configured to perform specified operations, such as a field programmable gate array (FPGA) or other suitable system. In still yet another exemplary embodiment, a computing node can refer to all or a portion of a system on a chip computing environment or cluster on chip computing environment.

Distributed computing environments generally execute software programs (computer executable algorithms) that are written in accordance with a distributed computing framework. An exemplary framework, in which aspects described herein can be practiced, is the map-reduce framework, although aspects described herein are not intended to be limited to such framework. The map-reduce framework supports map operations and reduce operations. Generally, a map operation refers to a master computing node receiving input, dividing such input into smaller sub-problems, and distributing such sub-problems to worker computing nodes. A worker node may undertake the task set forth by the master node and/or can further partition and distribute the received sub-problem to other worker nodes as several smaller sub-problems. In a reduce operation, the master node collects output of the worker nodes (answers to all the sub-problems generated by the worker nodes) and combines such data to form a desired output. The map and reduce operations can be distributed across multiple computing nodes and undertaken in parallel so long as the operations are independent of other operations. As data in the map reduce framework is distributed between computing nodes, key/value pairs are employed to identify corresponding portions of data.

The system 100 comprises a data store 102, which is a computer-readable data storage device that can be retained on a single computing device or distributed across several computing devices. The data store 102, therefore, may be a portion of memory, a hard drive, a flash drive, or other suitable computer readable data storage device. The data store 102 comprises a document corpus 104 that includes a plurality of documents 106-108 (e.g., a first document 106 through a Zth document 108). In an exemplary embodiment, the document corpus 104 may be relatively large in size, such that the document corpus 104 may consume multiple terabytes, petabytes, or more of computer-readable data storage. In an exemplary embodiment, the plurality of documents 106-108 may be a respective plurality of web pages in a search engine index. In another exemplary embodiment, the plurality of documents 106-108 may be a respective plurality of micro-blogs generated by users of a web-based micro-blogging application. A micro-blogging application is one in which content generated by users is limited to some threshold number of characters, such as 140 characters. In yet another exemplary embodiment, the plurality of documents 106-108 can be status messages generated by users of a social networking application, wherein such status messages are made available to the public by generators of such messages. In still yet another exemplary embodiment, the plurality of documents 106-108 can be scholarly articles whose topics are desirably automatically identified. Other types of documents are also contemplated, as the aforementioned list is not intended to be exhausting, but has been set forth for purposes of explanation.

The system 100 additionally comprises a frequency mapper component 110, a sorter component 112, a frequency reducer component 114, and a document labeler component 116. The components 110-116 may be executed cooperatively by a plurality of computing nodes that are in communication with one another, directly or indirectly. Accordingly, one or more of the component 110-116 may be executing on a single computing node or distributed across several computing nodes. Likewise, separate instances of the component 110-116 can be executing in parallel on different computing nodes in a distributed computing environment.

Each document in the plurality of documents 106-108 comprises a respective plurality of terms. As used herein, a term can be a word or an N-gram, wherein a value of N can be selected based upon a length of a phrase that is desirably considered. The frequency mapper component 110 receives the document corpus 104, and for each document in the document corpus 104 and for each term in each document of the document corpus 104, the frequency mapper component 110 can compute a respective term frequency value, wherein a term frequency value for a term in a document is indicative of a number of occurrences of the term in the document relative to a total number of terms in the document. In an example, if the first document 106 includes 100 terms (wherein the 100 terms may include duplicate terms) and the term “ABC” occurs 5 times in the first document 106, then the term frequency value for the term “ABC” in the first document 106 can be

$$\frac{1}{20} .$$

Again, the frequency mapper component 110 can compute a respective term frequency value for each term in each document of the document corpus 104.

In an exemplary embodiment, the frequency mapper component 110 can compute a respective term frequency value for each term in each document of the document corpus 104 in a single pass over the plurality of documents 106-108 in the document corpus 104. Pursuant to an example, the system 100 can comprise a memory buffer 118 that resides on a computing node that executes an instance of the frequency mapper component 110. Upon receiving a document (document X) from the document corpus 104, the frequency mapper component 110 can cause content 120 of document X (an exhaustive list of terms, including duplicative terms, included in document X) to be stored in the memory buffer 118. As will be described in greater detail below, the frequency mapper component 110 can analyze each term in the content 120 of document X in the memory buffer 118, and can compute term frequency values for respective unique terms in the content 120 of document X. Additionally, the frequency mapper component 110 can output data packets that are indicative of such respective term frequency values, discard the content 120 of document X from the memory buffer 118, and load content of another document from the document corpus 104 into the memory buffer 118 for purposes of analysis. Using this approach, documents in the document corpus 104 need not be analyzed multiple times by the frequency mapper component 110 to compute term frequency values for terms included in documents of the document corpus 104.

For each unique term in each document loaded into the memory buffer 118 by the frequency mapper component 110, the frequency mapper component 110 can output a plurality of data packets. For instance, for each unique term in document X, the frequency mapper component 110 can output a respective first data packet and a respective second data packet. The respective first data packet indicates that a respective term occurs in document X, while the second data packet indicates a term frequency value for the respective term in document X.

The sorter component 112 receives pluralities of data packets output by multiple instances of the frequency mapper component 110 and sorts such data packets, such that the values corresponding to identical terms (without regard to documents that include such terms) are aggregated. As will be shown below, aggregation of values in this manner allows for a number of documents that include each respective unique term that occurs in at least one document in the document corpus 104 to be efficiently computed.

In more detail, the frequency reducer component 114 receives sorted data packets output by the sorter component 112 and computes the metric that is indicative of descriptiveness of each term in each document of the document corpus 104 relative to respective content of a respective document that includes a respective term based upon sorted data packets output by the sorter component 112. As discussed above, the sorter component 112 aggregates values corresponding to data packets pertaining to identical terms output by the frequency mapper component 110. The frequency reducer component 114 can sum the aggregate values, which facilitates computing, for each term included in any document of the document corpus 104, a number of documents that include such term. The frequency reducer component 114 can additionally receive or compute a total number of documents included in the document corpus 104. Based upon the total number of documents in the document corpus 104 and a number of documents that include a respective term, the frequency reducer component 114 can compute an inverse document frequency value for each unique term in any document of the document corpus 104. The frequency reducer component 114 can also receive for each term in each document of the document corpus 104, a respective term frequency value computed by the frequency mapper component 110. Based upon such values, the frequency reducer component 114 can compute, for each term in each document of the document corpus 104, a respective metric that is indicative of descriptiveness of a respective term with respect to the document that includes the respective term (TF-IDF value for the term in the document).

An exemplary algorithm that can be employed by the frequency reducer component 114 to compute TF-IDF values for respective terms in documents of the document corpus 104 is as follows:

$$w ( t , d ) = TF ( t , d ) \times IDF ( t , D ) = \frac{\vert t \vert}{\vert d \vert} \times log ( \frac{\vert D \vert}{\vert \{ d \text{:} t ∈ d \} \vert} ) ,$$

where w(t, d) is the metric (TF-IDF value), |t| is a number of times that term t occurs in document d, |d| is the number of terms contained in the document d, |D| is the number of documents included in the document corpus D, and |{d:tεd}| is the number of documents in the corpus D that include the term t.

A document labeler component 116 receives, for each term in each document of the document corpus 104, a respective value output by the frequency reducer component 114, and selectively assigns a label to a respective document based at least in part upon the value. For instance, if the value (for a particular term in a certain document) is relatively high, the document labeler component 116 can indicate that such term is highly descriptive of content of the document. Accordingly, for instance, if a query is issued that includes the term, the document can be placed relatively highly in a ranked list of search results. In still other embodiments, the document can be assigned a particular categorization or classification based upon the value for a term. Other labels are also contemplated and are intended to fall under the scope of the hereto-appended claims.

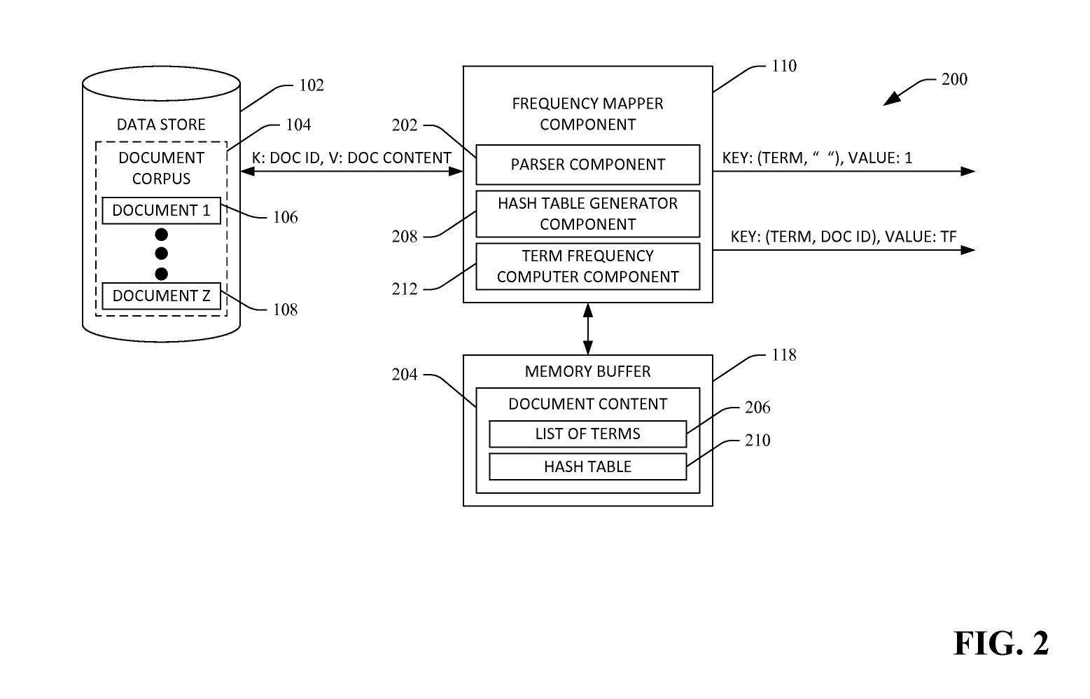

With reference now to FIG. 2, an exemplary system 200 that facilitates computing, for each term in each document of the document corpus 104, a respective term frequency value is illustrated. The system 200 comprises the data store 102, which includes the document corpus 104. The document corpus 104 comprises the plurality of documents 106-108, and each document in the plurality of documents 106-108 comprises a respective plurality of terms. The system 200 further comprises the frequency mapper component 110, which receives documents from the document corpus 104. As mentioned above, the frequency mapper component 110, in an exemplary embodiment, can be configured to execute in accordance with the map-reduce programming framework. Accordingly, the frequency mapper component 110 receives data packets in the form of key/value pairs and outputs data packets in the form of key/value pairs. In an exemplary embodiment, the frequency mapper component 110 can receive document content in the form of a key/value pair, wherein a key of the key/value pair is a document ID which uniquely identifies the document from amongst other documents in the document corpus 104, and wherein a value of the key/value pair is content of the document (terms included in the respective document).

The frequency mapper component 110 includes a parser component 202 that receives the key/value pair and causes document content 204 to be retained in the memory buffer 118. Specifically, the parser component 202 can generate an array that comprises a list of terms 206 in the document (wherein such list of terms can include several occurrences of a single term).

A hash table generator component 208 generates a hash table 210 in the memory buffer 118, wherein the hash table is organized such that a key thereof is a respective term in the list of terms 206 and a corresponding value in the hash table is indicative of a number of occurrences of the respective term in the list of terms 206. In an exemplary embodiment, the hash table generator component 208 operates in the following manner. The hash table generator component 208 accesses the list of terms 206 and selects, in sequential order, a term in the list of terms 206. The hash table generator component 208 then accesses the hash table 210 to ascertain whether the hash table 210 already comprises the term as a key thereof. If the hash table 210 does not comprise the term, then the hash table generator component 208 updates the hash table 210 to include the term with a corresponding value of, for example, 1 to indicate that (up to this point in the analysis) the document includes the term once. Additionally, the hash table generator component 208 causes a key/value pair to be output when initially adding a term to the hash table 210. A key of such key/value pair is a compound key, wherein a first element of the compound key is the term and a second element of the compound key is a wildcard. For instance, the wildcard can be a negative value or/and empty value. Effectively, this key/value pair indicates that the term is included in the document (even though the document is not identified in the key/value pair).

If the term analyzed by the hash table generator component 208 is already existent in the hash table 210, then the hash table generator component 208 increments the corresponding value for the term in the hash table 210. The resultant hash table 210, then, includes all unique terms of in the document and corresponding numbers of occurrences of the terms in the document.

The frequency mapper component 110 also comprises a term frequency computer component 212 that, for each term in the hash table 210, computes a term frequency value for a respective term, wherein the term frequency value for the respective term is indicative of a number of occurrences of the term in the document relative to a total number of terms in the document. The term frequency computer component 212 computes such values based upon content of the hash table 210. For example, the term frequency computer component 212 can sum values in the hash table to ascertain a total number of terms included in the document. In an alternative embodiment, the frequency mapper component 110 can compute the total number of terms in the document by counting terms in the list of terms 206. The term frequency computer component 212 can, for each term in the hash table 210, divide the corresponding value in the hash table 210 (the total number of occurrences of a respective term in the document) by the total number of terms in the document. The term frequency computer component 212 can subsequently cause a respective second key/value pair to be output for each term in the hash table 210, wherein a key of such key/value pair is a compound key, wherein a first element is a respective term, the a element is a document identifier, and wherein a value of the key/value pair is the respective term frequency for the respective term in the document. Thus, it is to be understood that the frequency mapper component 110 outputs two key/value pairs for each unique term in the document (for each term in the hash table 210): a first key/value pair, wherein a first key of the first key/value pair comprises the term and the wildcard, and wherein a first value of the first key/value pair is, for example, 1; and a second key/value pair, wherein a second key of the second key/value pair comprises the term and the document identifier, and wherein a second value of the second key/value pair is the term frequency for the respective term in the document.

Exemplary pseudo-code corresponding to the frequency mapper component 110 is set forth below for purposes of explanation.

| | |
|---|---|
| 1: | class TF-IDF Computation Mapper |

| | |
|---|---|
| 2: | method map(k: doc id, v: doc content) |

| | |
|---|---|
| 3: | creates hash table(k: term, v: count) x |
| 4: | parses the content into a list of terms |
| 5: | d ← size of the list (the number of terms in the doc) |
| 6: | for each term in list |

| | |
|---|---|
| 7: | if x contains key term |

| | |
|---|---|
| 8: | x.get(term).count ← x.get(term).count + 1 |

| | |
|---|---|
| 9: | else |

| | |
|---|---|
| 10: | x ← (term, 1) |

| | |
|---|---|
| 11: | emits: key=(term, “”),value=1 |

| | |
|---|---|
| 12: | for each term in x.keySet |

| | |
|---|---|
| 13: | tf ← x.get(term).count / d |
| 14: | emits: key=(term, doc id),value=tf |

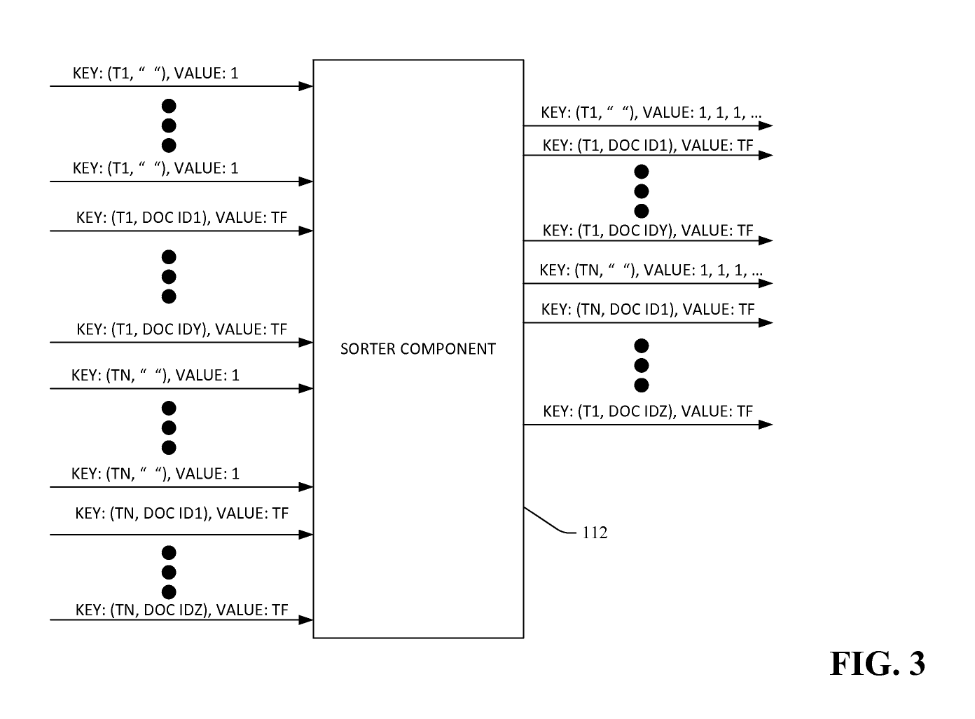

Now referring to FIG. 3, an exemplary operation of the sorter component 112 is depicted. The sorter component 112 effectively aggregates the values of key/value pairs with equivalent keys. As described above, the frequency mapper component 110 outputs a key/value pair for a term in a document, wherein the key/value pair fails to explicitly identify the document in the key of such key/value pair; rather, a wildcard (e.g., “ ”) is employed in such key. This causes the frequency mapper component 110 to generate equivalent keys when a term is included in separate documents. Accordingly, as shown, the sorter component 112 can receive key/value pairs with the key (T1, “ ”), numerous times. When sorting the key/value pairs, the sorter component aggregates the values of key/value pairs with equivalent keys. Thus, the sorter component 112 outputs the key/value pair (T1, “ ”), (1,1,1, . . . ). The number of values in a key/value pair output by the sorter component 112, wherein the key comprises the wildcard character, is indicative of a number of documents that include the term identified in the key. Therefore, a second pass over the document corpus 104 need not be undertaken to compute an inverse document frequency value for a respective term in a document of the document corpus 104.

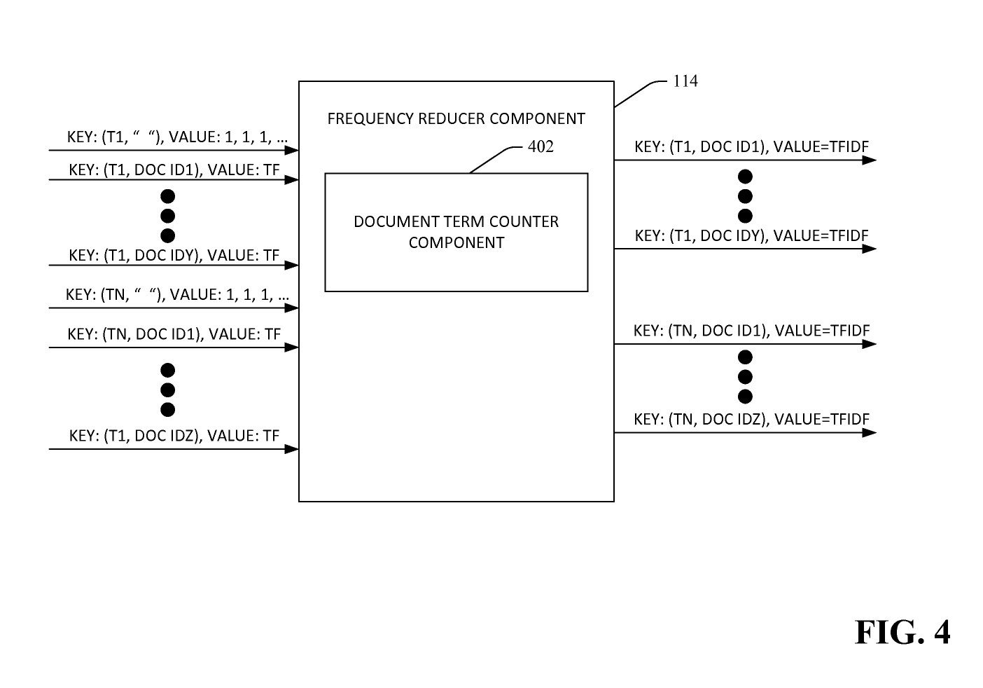

Now referring to FIG. 4, an exemplary operation of the frequency reducer component 114 is illustrated. The frequency reducer component 114 receives key/value pairs output by the sorter component 112. The frequency reducer component 114 comprises a document term counter component 402 that computes a respective number of documents that include a respective unique term in a document of the document corpus 104. Specifically, the document term counter component 402 receives key/value pairs, and for each key/value pair that includes a wildcard as a portion of the key, sums corresponding values in the key/value pair. For instance, the sorter component 112 can output the key/value pair (T1, “ ”), (1, 1, 1, 1). The document term counter component 402 can sum the values in this key/value pair and ascertain that the term T1 occurs in four documents of in document corpus. The frequency reducer component 114 can then compute, for each unique term in the document corpus 104, a respective inverse document frequency, wherein the inverse document frequency is log

$$( \frac{\vert D \vert}{\vert \{ d \text{:} t ∈ d \} \vert} ) ,$$

defined above. The frequency reducer component 114 can thereafter compute a respective TF-IDF value for each term in each document of the document corpus 104. Therefore, for each term/document combination, the frequency reducer component 114 can output a respective TF-IDF value. This can be in the form of a key/value pair, wherein a key of the key/value pair is a compound key, wherein a first element of the compound key is a respective term, and a second element of the compound key is a respective document that includes the respective term, and a respective value of the key/value pair is the TF-IDF for the term/document combination.

Exemplary pseudocode that can be executed by the frequency reducer component 114 is set forth below for purposes of explanation.

| | |
|---|---|
| 1: | class TF-IDF Computation Reducer |

| | |
|---|---|
| 2: | n ← total number of documents in corpus |
| 3: | m ← 0 (number of documents containing the term) |
| 4: | method reducer (k: (term, doc id), v: list of tfs) |

| | |
|---|---|
| 5: | if doc id is empty |

| | |
|---|---|
| 6: | m ← 0 |
| 7: | for each tf in tfs |

| | |
|---|---|
| 8: | m ← m + tf |

| | |
|---|---|
| 9: | else |

| | |
|---|---|
| 11: | tfidf ← 0 |
| 12: | for tf in tfs |

| | |
|---|---|
| 13: | tfidf ← tf |

| | |
|---|---|
| 14: | tfidf ← tf*log(n/m) |

| | |
|---|---|
| 15: | emits: key=(term, doc id), value=tfidf |

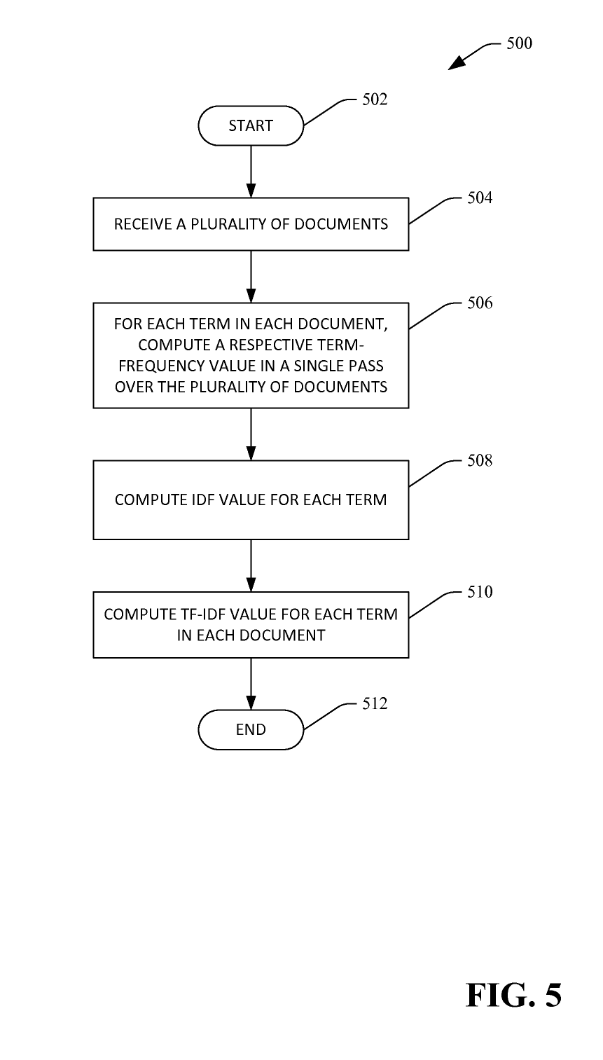

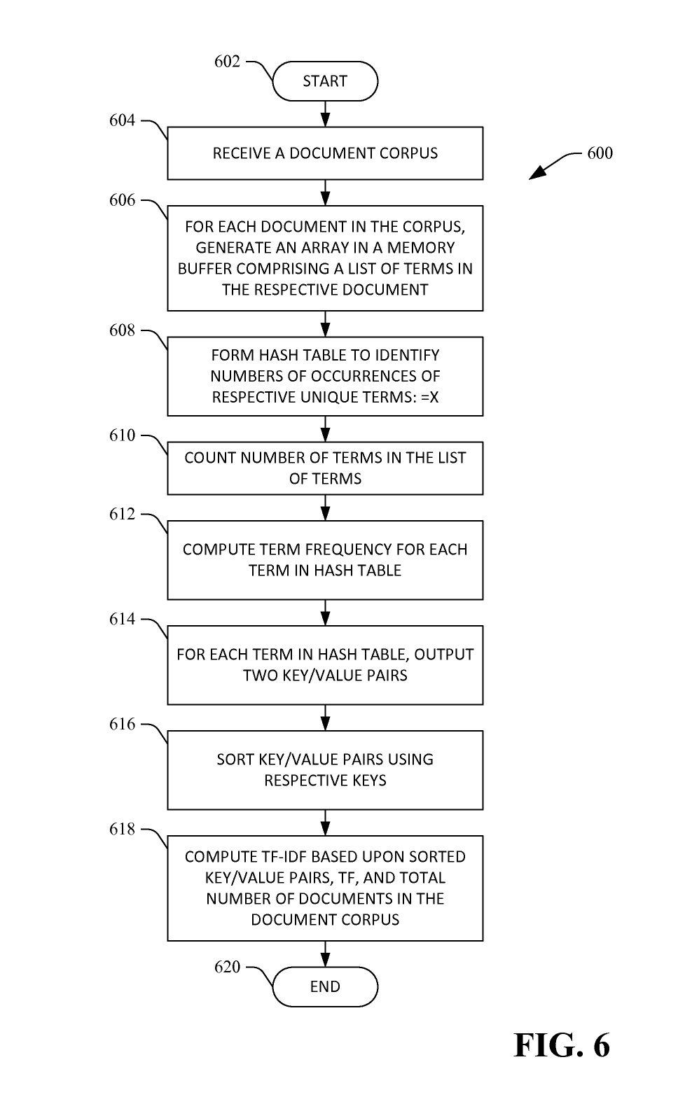

With reference now to FIGS. 5-6, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Now referring to FIG. 5, an exemplary methodology 500 that facilitates computing a respective TF-IDF value for each term in each document of a document corpus is illustrated. The methodology 500 is configured for execution in a distributed computing environment that comprises a plurality of computing nodes that are directly or indirectly in communication with one another. The plurality of computing nodes comprises a first subset of computing nodes and a second subset of computing nodes. The methodology 500 starts at 502, and at 504, at the first subset of computing nodes, a plurality of documents are received, wherein each document in the plurality of documents comprises a plurality of terms. At 506, at the first subset of computing nodes, for each term in each document in the plurality of documents, a respective term frequency value is computed, wherein term frequency values for respective terms in the plurality of documents are computed in a single pass over the plurality of documents.

At 508, at the second subset of computing nodes in the plurality of computing nodes, a respective inverse document frequency value is computed for each unique term existent in any of the documents in the plurality of documents. At 510, a respective TF-IDF value is computed based at least in part upon the respective term frequency value computed at 506 and the respective IDF value computed at 508. TF-IDF values are computed without re-inputting the plurality of documents (e.g., TF-IDF values are computed in a single pass over the plurality of documents). The methodology 500 completes at 512.

Now referring to FIG. 6, an exemplary methodology 600 that facilitates computing a respective TF IDF value for each term in each document of a document corpus is illustrated. The methodology 600, for instance, can be executed collectively by a plurality of computing nodes in a distributed computing environment. The methodology 600 starts at 602, and at 604 a document corpus is received. The document corpus comprises a plurality of documents, each document in the plurality of documents comprising a plurality of terms.

At 606, for each document in the document corpus, an array in a memory buffer is generated, wherein the array comprises a list of terms in the respective document (including duplicative terms). At 608, a hash table is formed in the memory buffer to identify numbers of occurrences of respective unique terms in the list of terms. Specifically, the hash table is organized in accordance with a key and a respective value, the key of the hash table being a respective term from the list of terms, a respective value of the hash table being a number of occurrences of the respective term in the list of terms in the memory buffer. Accordingly, the hash table is populated with terms and respective values, wherein terms in the hash table are unique (no term is listed multiple times in the hash table).

At 610, a total number of terms in the respective document is counted by summing the values in the hash table. At 612, for each term in the hash table for the respective document, a respective term frequency value is computed.

At 614, for each term in the hash table, a respective first key/value pair and a respective second key/value pair are output. The respective first key/value pair comprises a first key and a first value. The first key comprises the respective term and a wildcard character. The first value indicates an occurrence of the respective term in the respective document. The respective second key/value pair comprises a second key and a second value, the second key comprising the respective term and an identifier of the respective document, the second value comprising the respective term frequency value for the respective term in the respective document.

At 616, key/value pairs are sorted based at least in part upon respective keys thereof. When such key/value pairs are sorted, values in key/value pairs with equivalent keys are aggregated. Values in key/value pairs with wildcard characters, subsequent to sorting, are indicative of a number of documents that include a respective term identified in the respective key of the key/value pair.

At 618, for each term in each document in the document corpus, a respective TF-IDF value is computed based at least in part upon the number of documents that include the respective term, a number of documents in the document corpus, and the respective term frequency value for the respective term in the respective document. The methodology 600 completes at 620.

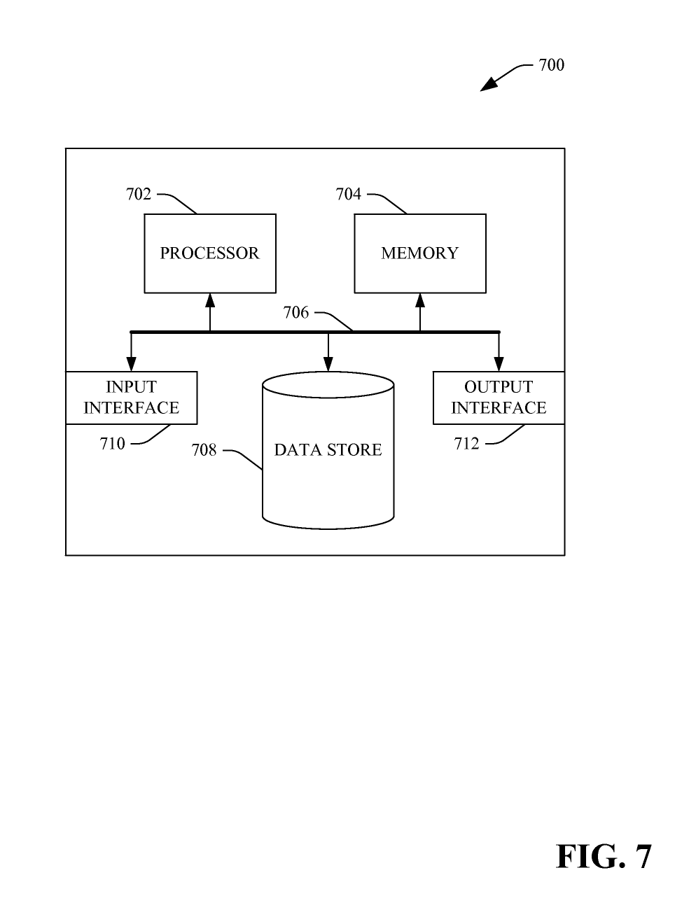

Now referring to FIG. 7, a high-level illustration of an exemplary computing device 700 that can be used in accordance with the systems and methodologies disclosed herein is illustrated. For instance, the computing device 700 may be used in a system that supports computing term frequency values for respective terms in a document. In another example, at least a portion of the computing device 700 may be used in a system that supports computing TF-IDF values for respective terms in respective documents of a document corpus. The computing device 700 includes at least one processor 702 that executes instructions that are stored in a memory 704. The memory 704 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store documents of a document corpus, term frequency values, etc.

The computing device 700 additionally includes a data store 708 that is accessible by the processor 702 by way of the system bus 706. The data store 708 may be or include any suitable computer-readable storage, including a hard disk, memory, etc. The data store 708 may include executable instructions, documents, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

Additionally, while illustrated as a single system, it is to be understood that the computing device 700 may be a distributed system. Thus, for instance, several devices may be in communication by way of a network connection and may collectively perform tasks described as being performed by the computing device 700.

While the computing device 700 has been presented above as an exemplary operating environment in which features described herein may be implemented, it is to be understood that other environments are also contemplated. For example, hardware-only implementations are contemplated, wherein integrated circuits are configured to perform predefined tasks. Additionally, system-on-chip (SoC) and cluster-on-chip (CoC) implementations of the features described herein are also contemplated. Moreover, as discussed above, features described above are particularly well-suited for distributed computing environments, and such environments may include multiple computing devices (such as that shown in FIG. 7), multiple integrated circuits or other hardware functionality, SoC systems, CoC systems, and/or some combination thereof.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method configured for execution in a distributed computing environment comprising a plurality of computing nodes that are directly or indirectly in communication with one another, the method comprising:
at at least one computing node in a first subset of computing nodes in the plurality of computing nodes, executing a plurality of acts, the plurality of acts comprising:
receiving a plurality of documents, each document in the plurality of documents comprising a plurality of terms;
in a single pass over the plurality of documents, for each document in the plurality of documents, and for each term in a respective document, computing a respective term frequency value that is indicative of a number of occurrences of a respective term in the respective document relative to a total number of terms in the respective document; and
outputting the respective term frequency value to at least one computing node in a second subset of computing nodes in the plurality of computing nodes; and
at the at least one computing node in the second subset of computing nodes in the plurality of computing nodes, executing a plurality of acts, the plurality of acts comprising:
receiving the respective term frequency value from the at least one computing node in the first subset of computing nodes;
computing a respective inverse document frequency value for each term in each document in the plurality of documents, the respective inverse document frequency value indicative of a number of documents in the plurality of document that comprise the respective term;
computing a metric that is indicative of descriptiveness of the respective term with respect to content of the respective document based at least in part upon the respective term frequency value and the respective inverse document frequency value; and
storing the metric in association with the respective document in a computer-readable data storage device.

2. The method of claim 1, wherein computing the respective term frequency value comprises executing a plurality of acts on the at least one computing node in the first subset of computing nodes, the plurality of acts executed by the at least one computing node in the first subset of computing nodes comprising:
parsing the respective document to generate a list of terms in the respective document;
storing the list of terms in a memory buffer of the at least one computing node in the first subset of computing nodes;
computing a total number of terms in the list of terms in the memory buffer; and
computing the respective term frequency value based at least in part upon the total number of terms in the list of terms in the memory buffer.

3. The method of claim 2, wherein the plurality of acts executed by the at least one computing node in the first subset of computing nodes further comprises:
constructing a hash table, wherein keys of the hash table are respective terms in the respective document, and wherein values of the hash table are respective numbers of occurrences of the respective terms in the respective document;
for each term in the list of terms in the memory buffer, accessing the hash table to ascertain whether the hash table comprises the respective term;
if the hash table comprises the respective term, increasing a respective value for the respective term in the hash table;
if the hash table fails to comprise the respective term, adding the respective term as a respective key in the hash table and updating a respective value for the respective key; and
computing the respective term frequency value based at least in part upon the respective value for the respective term in the hash table.

4. The method of claim 3, wherein the plurality of acts executed by the at least one computing node in the first subset of computing nodes further comprises:
if the hash table fails to comprise the respective term, outputting a data packet to the second subset of computing nodes that indicates that the respective document comprises the respective term.

5. The method of claim 4, wherein the plurality of acts executed by the at least one computing node in the first subset of computing nodes further comprises:
sorting data packets output by the at least one computing node in the first subset of computing nodes based at least in part upon the indication that the respective document comprises the respective term; and
aggregating values in the data packets based at least in part upon the sorting of the data packets, wherein aggregated values are indicative of the number of documents in the plurality of documents that comprise the respective term; and
outputting the aggregated values to the at least one computing node in the second subset of computing nodes.

6. The method of claim 5, further comprising executing a plurality of acts on the at least one computing node in the second subset of computing nodes, the plurality of acts executed on the at least one computing node in the second subset of computing nodes comprising:
receiving the aggregated values output by the at least one computing node in the first subset of computing nodes; and
computing the number of documents in the plurality of documents that comprise the respective term based at least in part upon the aggregated values.

7. The method of claim 6 configured for execution in a distributed computing environment programming framework.

8. The method of claim 7, the distributed computing environment programming framework being a map-reduce framework.

9. The method of claim 1, wherein the respective term comprises multiple words.

10. The method of claim 1, wherein the plurality of documents are a plurality of web pages.

11. The method of claim 1, wherein the plurality of web pages are a plurality of micro-blogging entries.

12. A system that facilitates computing a respective metric of descriptiveness of each term of each document in a document corpus with respect to content of a respective document that comprises a respective term, the system comprising:
a plurality of computing nodes that are directly or indirectly in communication with one another, the plurality of computing nodes executing a plurality of computer-executable components cooperatively through utilization of a distributed computing framework, the plurality of computer-executable components comprising:
a frequency mapper component that receives the document corpus that comprises a plurality of documents, each document in the plurality of documents comprising a respective plurality of terms, the frequency mapper component computing a respective term frequency value for each term in each document, wherein a term frequency value for the respective term in the respective document is indicative of a number of occurrences of the respective term in the respective document; and
a frequency reducer component that receives term frequency values for respective terms in respective documents and computes, for each of the terms in each of the documents, the respective metric of descriptiveness, the respective metric of descriptiveness for the respective term in the respective document computed based at least in part upon the respective term frequency value for the respective term in the respective document, a number of documents in the document corpus, and a number of documents in the document corpus that include the term, wherein the respective metric is computed for the respective term in the respective document in a single input pass over the document corpus.

13. The system of claim 12, wherein the distributed computing framework is a map-reduce framework.

14. The system of claim 13, wherein the frequency mapper component comprises:
a parser component that receives the respective document from the document corpus, generates a list of terms included in the respective document, and stores the list of terms in a memory buffer of a computing node in the plurality of computing nodes;
a hash table generator component that generates a hash table and populates the hash table with unique terms in the list of terms and respective values that indicate respective numbers of occurrences of the respective unique terms in the list of terms, wherein the hash table is stored in the memory buffer; and
a term frequency computer component that computes term frequency values for respective unique terms in the hash table based at least in part upon a number of terms in the list of terms and the respective values in the hash table.

15. The system of claim 14, wherein the hash table generator component, for each unique term in the list of terms, outputs a first respective key/value pair, wherein a key of the first respective key/value pair comprises the respective term and a wildcard character, and wherein a value of the first respective key/value pair comprises a value that indicates an occurrence of the respective term in the respective document.

16. The system of claim 15, wherein the term frequency computer component, for each unique term in the list of terms included in the document, outputs a second respective key/value pair, wherein a second key of the second respective key/value pair comprises the respective term and an identifier of the respective document, and wherein a value of the second respective key/value pair comprises the respective term-frequency value.

17. The system of claim 16, wherein the plurality of components further comprise a sorter component that sorts key/value pairs output by the hash table generator component based at least in part upon respective keys of the key/value pairs, wherein the sorter component aggregates values of key/value pairs that have equivalent keys, wherein the sorter component outputs sorted key/value pairs to the frequency reducer component.

18. The system of claim 13, wherein each term comprises multiple words.

19. The system of claim 13, wherein the plurality of documents are a plurality of web pages, and wherein a search engine ranks a subset of the plurality of web pages in a list of search results responsive to receipt of a user query based at least in part upon respective metrics of descriptiveness of terms in the subset of the plurality of web pages.

20. A computer-readable medium comprising instructions that, when executed collectively by a plurality of computing nodes in a distributed computing environment, cause the plurality of computing nodes to perform acts, comprising:
receiving a document corpus, the document corpus comprising a plurality of documents, each document in the plurality of documents comprising a plurality of terms;
for each document in the plurality of documents, generating a respective array in a memory buffer of a computing node from amongst the plurality of computing nodes, the respective array comprising a list of terms in a respective document;
counting a number of terms in the list of terms and storing the number in the memory buffer;
forming a hash table in the memory buffer, the hash table comprising a key and a respective value, the key of the hash table being a respective term from the list of terms, the respective value of the hash table being a respective number of occurrences of the respective term in the list of terms in the respective document;
populating the hash table with unique terms and respective values;
computing, for each term in the hash table, a respective term frequency value, the respective term frequency value indicative of a number of occurrences of the respective term in the hash table relative to the number of terms in the list of terms;
for each term in the hash table, outputting a respective first key/value pair and a respective second key/value pair, the respective first key/value pair comprising a first key and a first value, the first key comprising the respective term and a wildcard, the first value indicating an occurrence of the respective term in the respective document, the respective second key/value pair comprising a second key and a second value, the second key comprising the respective term and an identifier for the respective document, the second value comprising the respective term frequency value for the respective term;
sorting key/value pairs based at least in part upon respective keys therein, wherein values in key/value pairs with equivalent keys are aggregated when sorted, and wherein aggregated values are indicative of a number of documents that include the respective term;
computing, for each term in each document in the document corpus, a respective term frequency-inverse document frequency value based at least in part upon the number of documents that include the respective term, a number of documents in the document corpus, and the respective term frequency value.
